(19) United States
(12) Patent Application Publication
(10) Pub. No.: US 2014/0153443 A1
(43) Pub. Date: Jun. 5, 2014

(54) Per-Address Spanning Tree Networks

(71) Applicant: INTERNATIONAL BUSINESS MACHINES CORPORATION, Armonk, NY (US)

(72) Inventors: John B. Carter, Austin, TX (US); Wesley M. Felter, Austin, TX (US); Brent E. Stephens, Houston, TX (US)

(73) Assignee: International Business Machines Corporation, Armonk, NY (US)

(21) Appl. No.: 13/690,712

(22) Filed: Nov. 30, 2012

(51) Int. Cl. H04L 12/56

(52) U.S. Cl. CPC H04L 45/54
USPC 370/256

(57) ABSTRACT

A mechanism is provided for implementing a per-address spanning tree (PAST) to direct the forwarding of packets in a set of switches. The per-address spanning tree is computed for each identified address in a set of addresses thereby forming a set of per-address spanning trees. A set of forwarding rules associated with each per-address spanning tree in the set of per-address spanning trees is generated and installed all appropriate switches in the set of switches for which the per-address spanning tree is generated so that each switch in the set of switches will forward packets based on the set of forwarding rules installed in that switch.

### BACKGROUND

The present application relates generally to an improved data processing apparatus and method and more specifically to mechanisms for implementing a per-address spanning tree algorithm for data center Ethernet networks.

The network requirements of modern data centers differ significantly from traditional networks, so traditional network designs often struggle to meet modern data center network requirements. For example, layer-2 Ethernet networks provide the flexibility and ease of configuration that network operators want, hut layer-2 Ethernet networks scale poorly and make poor use of available bandwidth. Layer-3 Internet Protocol (IP) networks provide better scalability and bandwidth, but are less flexible and are more difficult to configure and manage. Network operators want the benefits of both designs, white at the same time preferring commodity hardware over expensive custom solutions in order to reduce costs.

### SUMMARY

In one illustrative embodiment, a method, in a data processing system, is provided for implementing a per-address spanning tree (PAST) in a set of switches. The illustrative embodiment computes the per-address spanning tree for each identified address in a set of addresses thereby forming a set of per-address spanning trees. The illustrative embodiment generates a set of forwarding rules associated with each per-address spanning tree in the set of per-address spanning trees. The illustrative embodiment then installs the set of forwarding rules associated with each per-address spanning tree in the set of per-address spanning trees in all appropriate switches in the set of switches for which the per-address spanning tree is generated so that each switch in the set of switches will forward packets based on the set of forwarding rules installed in that switch.

In other illustrative embodiments, a computer program product comprising a computer useable or readable medium having a computer readable program is provided. The computer readable program, when executed on a computing device, causes the computing device to perform various ones of, and combinations of the operations outlined above with regard to the method illustrative embodiment.

In yet another illustrative embodiment, a system/apparatus is provided. The system/apparatus may comprise one or more processors and a memory coupled. to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 depicts a block diagram of an exemplary switch in accordance with an illustrative embodiment;

FIG. 4 presents a high-level overview of a relevant portion of a typical Ethernet switch packet processing pipeline in accordance with an illustrative embodiment;

FIG. 5 illustrates an approximate size of tables used for several commodity Ethernet switch chips in accordance with an illustrative embodiment;

FIG. 6 depicts a functional block diagram of a per-address spanning tree (PAST) mechanism is accordance with an illustrative embodiment;

FIG. 7 depicts a flowchart of the operation performed by a per-address spanning tree (PAST) mechanism during initialization of a network in accordance with an illustrative embodiment;

FIG. 8 depicts a flowchart of the operation performed by a per-address spanning tree (PAST) mechanism responsive to an address being added or migrated in accordance with an illustrative embodiment; and

FIG. 9 depicts a flowchart of the operation performed by a per-address spanning tree (PAST) mechanism responsive to a link being added or deleted in accordance with an illustrative embodiment.

### DETAILED DESCRIPTION

The illustrative embodiments described herein are related to implementing efficient packet forwarding on network switches and/or routers. To forward packets across a network, each switch and/or router must be programmed with a set of match-action rules that specify how to process any packet that the switch and/or router might receive. The most common action that a switch or router performs upon receiving a packet is to forward the packet out a particular output port or set of output ports. The most common mechanism for programming forwarding tables in layer-2 Ethernet networks is to run a distributed Spanning Tree Protocol (STP) mechanism in order to build a single logical spanning tree encompassing all of the switches in the network. All packets are forwarded along this single spanning tree. The SPT mechanism guarantees that all forwarding paths are cycle-free, but makes poor use of available bandwidth for network topologies in which there are multiple paths between sources and destinations within the network, such as HyperX, Jellyfish, or the like.

Thus, the mechanisms of the illustrative embodiments provide a per-address spanning tree (PAST) enabled forwarding mechanism that implements a flat layer-2 data center network architecture that supports very large numbers of hosts (typically over 100,000), provides full host mobility, provides high end-to-end bandwidth, and provides autonomous route construction on top of commodity Ethernet switches. When a host joins the network or the host migrates within the network, a new spanning tree is installed to carry traffic destined for that host. This spanning tree may be implemented using only entries in the large Ethernet (exact match) forwarding table present in commodity switch chips, which allows the PAST mechanism to scale to very large numbers of hosts. In aggregate, trees spread traffic across all links in the network, so PAST provides equal or greater aggregate bandwidth as layer-3 equal-cost multi-path (ECMP) routing. The PAST mechanism provides Ethernet semantics and runs on unmodified switches and hosts without modifying the virtual LAN (VLAN) or other header fields. Finally, the PAST mechanism works on arbitrary network topologies, including HyperX, Jellyfish, or the like, which may perform as well or better than Fat Tree topologies at a fraction of the cost.

The PAST mechanism may be implemented in either a centralized or distributed fashion. That is, while the preferred embodiments are directed to a centralized software-defined network (SDN) architecture, one of ordinary skill in the art would realize that a distributed network may also be implemented where the described PAST architecture may be implemented utilizing one or more of the switches within the network rather than a centralized PAST controller. The described preferred embodiments are directed to a centralized software-defined network (SDN) architecture that computes the trees on a high-end server processor rather than using the control plane processors present in commodity Ethernet switches to negotiate each tree. An Openflow-based PAST implementation is described to consider the kinds of match-action rules present in commodity switch hardware, the number of rules per table, and the speed with which rules may be installed. By restricting the PAST mechanism to route solely using destination Media Access Control (MAC) addresses and VLAN tags, the illustrative embodiments may utilize the large layer-2 forwarding table present in typical L2 Ethernet switches, rather than retying on the more general, but much smaller, Ternary Content Addressable Memory (TCAM) table, as is done in previous OpenFlow architectures.

Therefore, the illustrative embodiments provide:
1. A novel network architecture that meets all of the requirements described above using a per-address spanning tree routing (PAST) mechanism.
2. An implementation that makes efficient use of the capabilities of commodity switch hardware.

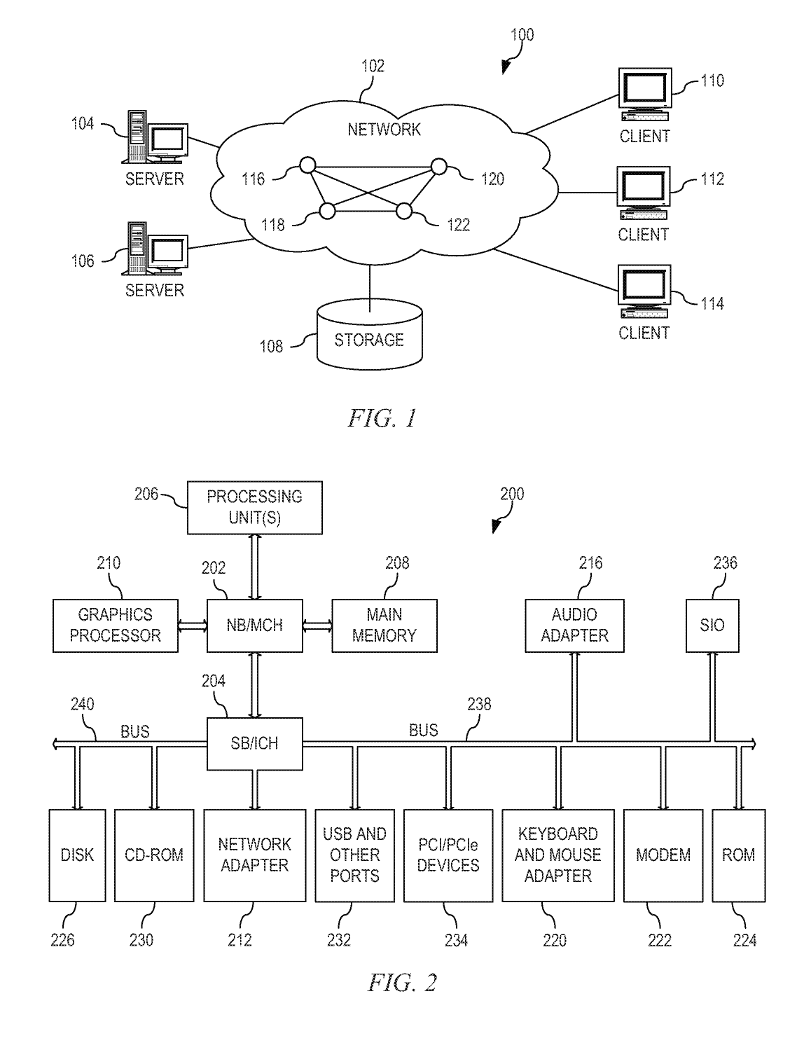

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connection devices such as switches, routers, or the like, and connections, such as wired communication links, wireless communication links, fiber optic cables, or the like.

In the depicted example, server 104 and server 106 are coupled to network 102 along with storage unit 108 and clients 110, 112, and 114 via connection devices, such as switches 116, 118, 120, and 122 which are themselves coupled to each other. These clients 110, 112, and 114 may be, for example, personal computers, network computers, or the like. In the depicted example, server 104 provides data, such as boot files, operating system images, and applications to the clients 110, 112, and 114. Server 104 may be a physical machine or a machine that is running one or more virtual machines. Clients 110, 112, and 114 are clients to server 104 in the depicted example. Distributed data processing system 100 may include additional servers, clients, and other devices not shown.

In the depicted example, distributed data processing system 100 is the data center network (DCN) representing a collection of switches and servers that utilize an Ethernet protocol to communicate with one another. Of course, the distributed data processing system 100 may also be implemented to include a number of different types of networks, such as for example, an Intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, white PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An Object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, switch, controller, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

While many vendors produce Ethernet forwarding hardware, the hardware tends to exhibit many similarities due in part to the use of “commodity” switch chips from vendors such as Broadcom™ and Intel® at the core of each switch. The following description focuses on an exemplary switch chip and Ethernet switch.

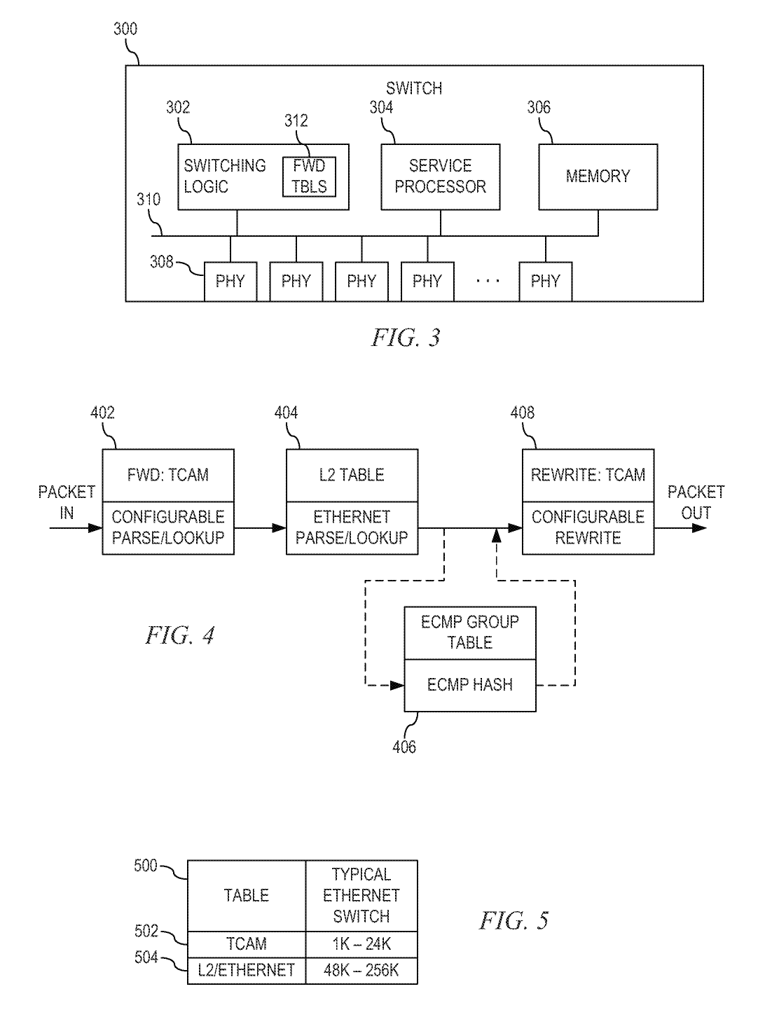

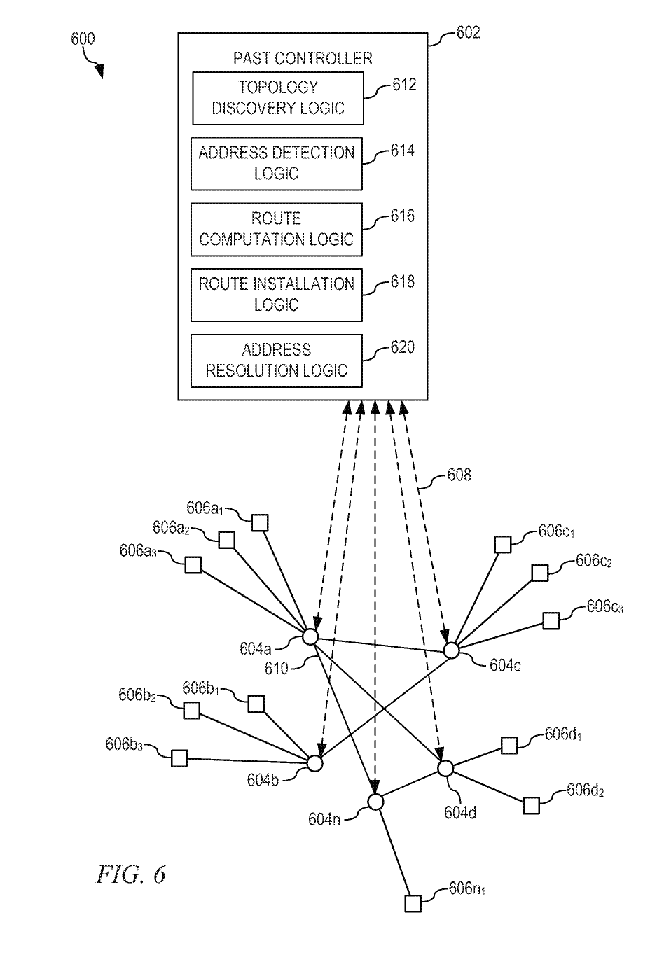

FIG. 3 depicts a block diagram of an exemplary switch in accordance with an illustrative embodiment. Switch 300 comprises switching logic 302, service processor 304, memory 306, and physical interface macros (PHYs) 308 coupled together via bus 310. As packets are received via one NAY 308, switching logic 302 parses a header of the packet to identify a destination address of the packet, utilizes one or more forwarding tables 312 to identify which of PHYs 308 that the packet should be sent out on, modifies the header of the packet if necessary, and sends the packet out on the identified PHY 308. Service processor 304 may exchange control messages with service processors in other switches to determine the network topology, e.g., using link layer discovery protocol (LLDP) messages. Service processor 304 may use this topology information to determine the forwarding topology over which packets should be forwarded and program the forwarding tables 312 to reflect this forwarding topology. Alternatively, service processor 304 may forward the network topology information to a network controller or, in accordance with the illustrative embodiments, a per-address spanning tree (PAST) controller, which may utilize this topology information to generate a preferred forwarding topology. In this embodiment, the per-address spanning tree (PAST) controller, which is described hereinafter in FIG. 6, would then communicate with service processor 304 in each switch to specify how packets should be forwarded, and each service processor 304 would update its local forwarding table 312 to reflect this specification.

FIG. 4 presents a high-level overview of a relevant portion of a typical Ethernet switch packet processing pipeline in accordance with an illustrative embodiment. Each of boxes 402, 404, 406, and 408 represents tables that map packets with certain header fields to one or more actions. Each table differs in which header fields may be matched, how many entries the table holds, and what kinds of actions the table allows. Typical actions include sending the packet out a specific port or forwarding the packet to another table. The order in which tables may be traversed is constrained; the allowed interactions are shown with directed arrows.

FIG. 5 illustrates an approximate size of tables used Dora typical Ethernet switch chip in accordance with an illustrative embodiment. Table 500 depicts estimated sizes for ternary content addressable memory (TCAM) tables 502 (boxes 402 and 408 of FIG. 4) and Layer-2 (L2)/Ethernet tables 504 (box 404 of FIG. 4), although many of the depicted commodity Ethernet switch chips include other tables such as Internet Protocol (IP) routing tables, equal-cost multi-path (ECMP) routing tables, data center bridging (DCB), Multiprotocol Label Switching (MIMS) tables, multicast tables, or the like, which are not discussed herewith.

L2/Ethernet table 504 performs an exact match lookup on two fields: virtual LAN (VLAN) identifier (ID) and destination Media Access Control (MAC) address. L2/Ethernet table 504 is by far the largest table in typical commodity switch chips. The output of L2/Ethernet table 504 is either an output port or a group, which may be thought of as a virtual port used to support multipathing or multicast.

The rewrite and forwarding TCAM table 502 provide wildcard match on most packet header fields, including per-bit wildcards. The rewrite portion of TCAM table 502 supports output actions that modify packet headers, while the forwarding portion of TCAM table 502 is used to more flexibly choose an output port or group. The greater flexibility of ICAM table 502 conies at a cost; despite consuming significant chip area, they typically contain only a few thousand entries.

The IBM® RackSwitch G8264 top-of-rack switch's OpenFlow 1.0 implementation allows OpenFlow rules to be installed in L2/Ethernet table 504. Specifically, if a rule is received that exact matches on (only) the Destination MAC address and VLAN ID, then the switch installs the rule in L2/Ethernet table 504. Otherwise, the switch installs the rule in the appropriate TCAM table 502, as is typical of OpenFlow implementations.

The switch chip is not a general-purpose processor, so switches typically contain a control plane processor that is responsible for programming the switch chip, providing the switch management interface, and participating in control plane protocols such as spanning tree protocol (SIP) or Open Shortest Path First (OSPF). In a software-defined network, the control processor also translates controller commands into switch chip state.

In traditional Ethernet, much of the forwarding state is learned automatically by the switch chip based on observed packets. A software defined approach shifts some of this burden to the control processor and external controller, adding latency and potential bottlenecks.

Generally, there are two approaches to scalable routing. The first approach entails making addresses topologically significant so routes may be aggregated in routing tables. The second approach is to include enough space in routing tables to allow for all routable addresses to have at least one entry.

As described above, the two layer-2 forwarding tables (exact-match and TCAM) differ in size by roughly two orders of magnitude. Given the small size of TCAM table 502, any routing mechanism that requires the flexibility of ICAM matching must aggregate routes, otherwise the few thousand TCAM entries per switch will be quickly exhausted. However, the larger size of L2/Ethernet table 504 means that any forwarding mechanism that matches only on destination MAC and VLAN ID has enough table space to install at least one entry per routable address per switch, even for large networks. Note that aggregation may not be used in the Ethernet forwarding table as it allows for exact matching only.

The per-address spanning tree (PAST) mechanism of the illustrative embodiments provides traditional Ethernet benefits of self-configuration and host mobility white using all available bandwidth in arbitrary topologies, scaling to a very large number of hosts, and running on current commodity hardware. PAST does so by installing routes in the L2/Ethernet table.

PAST's design is guided by the structure of commodity switches' Ethernet forwarding tables. Any routing algorithm that expresses forwarding rules as a mapping from a <Destination MAC addr, VLAN ID> pair to an output port or small set of ports may be implemented using the large Ethernet forwarding table. By design, an arbitrary spanning tree may be represented using rules of this form. The Ethernet table of current commodity switches is designed to support the traditional spanning tree protocol (STP), which implements a single spanning tree that is used to forward traffic destined for all destination hosts. However, these same Ethernet tables may also implement a separate spanning tree per destination host, which results in a per-address spanning tree (PAST). It is possible to construct a spanning tree for any connected topology, so PAST is topology-independent.

The network topologies considered by the illustrative embodiments have high path diversity, so many possible spanning trees may be built for each address. Each individual tree uses only a fraction of the links in the network, so it is beneficial to make the different trees as disjoint as possible to improve aggregate network utilization. Thus, unlike traditional L2/Ethernet networks, PAST can benefit from network topologies with high degrees of multipathing, such as HyperX, Jellyfish, or the like.

One variant of the PAST mechanism builds destination rooted shortest-path spanning trees. The intuition behind the PAST mechanism building such trees is that shortest-path spanning trees reduce latency and minimize load on the network. This PAST mechanism employs a breadth-first search (BFS) logic, to construct the shortest-path spanning trees for every address in the network. This spanning tree, rooted at the destination, provides a minimum-hop-count path from any point in the network to that destination.

An alternative PAST mechanism builds destination rooted non-minimal spanning trees by selecting a random switch in the network to act as an intermediary, building a minimal spanning tree that connects all switches to this intermediary switch, then reversing the direction of the tree edges along the path from the destination to the intermediary. This mechanism implements a form of Valiant routing. The resulting non-minimal spanning tree improves path diversity within a collection of PAST trees at the expense of increasing the average length of paths in the network.

Any given switch only uses a single path for forwarding traffic to each host. These paths are guaranteed to be loop-free because they form a tree. No links are ever disabled. Because a different spanning tree is used for each destination, the forward and reverse paths between two hosts in a PAST network are not necessarily symmetric.

The PAST mechanism is not concerned whether an address (MAC address-WAN pair) represents a VM, a host, or a switch, which is provided as a choice to the network operator. Since the PAST mechanism supports very large numbers of addresses on commodity hardware, there is no need to share, rewrite, or virtualize addresses in a network when there are fewer hosts than there are rules that fit in the large L2/Ethernet exact-match table. Likewise, a host may use any number of addresses if the host wishes to increase path diversity at the cost of increased forwarding state.

When building each spanning tree, there are often multiple options for the next-hop link. The illustrative embodiment described herein employs a random next hop selection policy, but one skilled in the art will recognize that many different selection policies may be utilized, such as random, guided, weighted, or the like. The way the PAST mechanism selects the next hop link may impact path diversity, load balance, and performance.

FIG. 6 depicts a functional block diagram of a per-address spanning tree (PAST) mechanism is accordance with an illustrative embodiment. Data processing system 600 comprises PAST controller 602, a set of switches 604a, 604b, 604c, 604d, . . . , 604n, and hosts 606a₁, 606a₂, 606a₃, 606b₁, 606b₂, 606b₃, 606c₁, 606c₂, 606c₃, 606d₁, 606d₂, . . . , 606n₁. As is illustrated hosts 606a₁, 606a₂, and 606a₃ are coupled to switch 604a, hosts 606b₁, 606b₂, and 606b₃ are coupled to switch 604b, hosts 606c₁, 606c₂, and 606c₃ are coupled to switch 606c, hosts 606d₁ and 606d₂ are coupled to switch 606d, and host 606n₁ is coupled to switch 606n. As is further shown, PAST controller 602 is coupled to each of the set of switches 604a, 604b, 604c, 604d, . . . , 604n, utilizing separate (out-of-band) control network 608 that is isolated from data network 610 which couples the set of switches 604a, 604b, 604c, 604d, . . . , 604n together. The isolation of control network 608 from data network 610 allows PAST controller 602 to bootstrap control network 608 and quickly recover from failures that could partition data network 610. However, in an event where all or a portion of control network 610 becomes unstable or unusable, or even as an alternative, one of ordinary skill in the art will recognize that PAST controller 602 may utilize data network 610 to send and receive PAST control messages.

PAST controller 602 comprises topology discovery logic 612, address detection logic 614, route computation logic 616, route installation logic 618, and address resolution logic 620. Topology discovery logic 612 sends and receives link layer discovery protocol (LLDP) messages or the like on each port of the set of switches 604a, 604b, 604c, 604d, . . . , 604n in the network. These LLDP messages discover whether a link connects to another switch or a host, and, if the port coupled to another switch, the identifier ID of the switch. Address detection logic 614 configures each of the set of switches 604a, 604b, 604c, 604d, . . . , 604n to snoop all address resolution protocol (ARP) traffic and forward all the ARP traffic to PAST controller 602. The gratuitous ARPs that are generated on host boot and migration by hosts 606a₁, 606a₂, 606a₃, 606b₁, 606b₂, 606b₃, 606c₁, 606c₂, 606c₃, 606d₁, 606d₂, . . . , 606n₁ provide timely notification of new or changed locations and trigger (re)computation of the per-address spanning tree for each identified address.

Upon discovering a new or migrated address, route computation logic 616 (re)computes the per-address spanning tree for each identified destination host (MAC address) and generates a set of forwarding rules (one per host) associated with the per-address spanning tree, which are used by the switch to determine how packet forwarding should be implemented per host. Further, when switches appear or disappear, route computation logic 616 recomputes all per-address spanning trees for each of the set of switches 604a, 604b, 604c, 604d, . . . , 604n and generates the set of forwarding rules associated with each per-address spanning tree. When a link goes down either between switches or between a switch and a host, route computation logic 616 recomputes only the per-address spanning trees that traverse that link and generates the set of forwarding rules associated with each per-address spanning tree. While new links appearing between switches or from a switch to a host do not affect existing per-address spanning trees, route computation logic 616 regularly rebuilds random per-address spanning trees and generates the set of forwarding rules associated with each random per-address spanning tree to gradually exploit new links and re-optimize existing per-address spanning trees.

Whenever a per-address spanning tree is (re)computed and the set of forwarding rules associated with each per-address spanning tree is generated, route installation logic 618 installs the associated set of forwarding rules in all associated switches in parallel. Route installation logic 618 installs the associated set of forwarding rules directly in the Ethernet table of the switch so that TCAM entries may be used for other purposes such as access control lists (ACLs) and traffic engineering. To ensure the associated set of forwarding rules are placed in the Ethernet table, route installation logic 618 ensures that each rule in the associated set of forwarding rules specify an exact match on destination MAC address and VLAN. In order to prevent the creation of a temporary routing loop, route installation logic 618 may remove all or a portion of previously installed forwarding rules associated with per-address spanning trees being replaced and issue a barrier to ensure they are purged, before installing the new set of forwarding rules associated with the (re)computed per-address spanning trees.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system,” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular mariner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

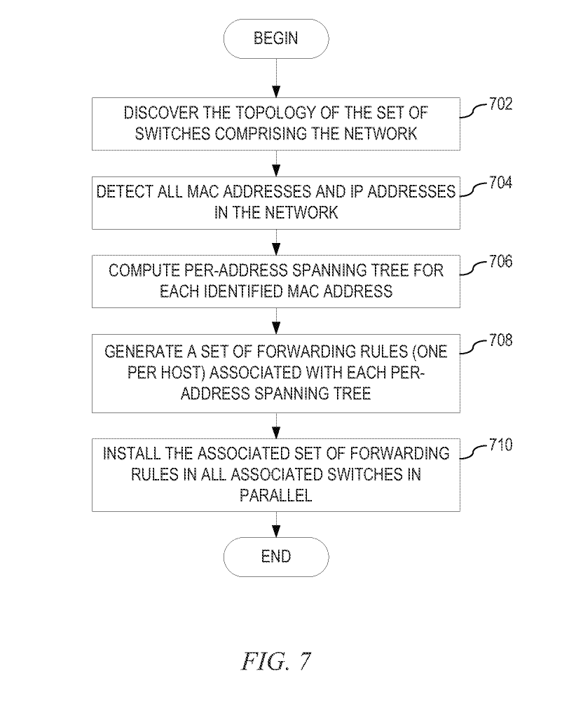

FIG. 7 depicts a flowchart of the operation performed by a per-address spanning tree (PAST) mechanism during initialization of a network in accordance with an illustrative embodiment. As the operation begins, the PAST mechanism, executed by a processor, causes each switch to send, receive, and forward link layer discovery protocol (LLDP) messages on each port of the set of switches in the network in order to discover whether the link connected to the port is another switch or a host, and, if the port coupled to another switch, the identifier ID of the switch, thereby discovering the topology of the set of switches comprising the network (step 702). The PAST mechanism then detects all MAC addresses and IP addresses in the network by configuring all of a set of switches to snoop and forward all traffic associated with the address resolution protocol (ARP) to the network controller (step 704). Upon discovering the MAC addresses and the connectivity of all in-use ports, the PAST mechanism computes the per-address spanning tree for each identified MAC address (step 706). The PAST mechanism then generates a set of forwarding rules (one per host MAC address) associated with each per-address spanning tree (step 708). The PAST mechanism then installs the associated set of forwarding rules in all associated switches in parallel (step 710), with the operation terminating thereafter. The PAST mechanism installs the associated set of forwarding rules directly in the Ethernet table of the switch so that TCAM entries may be used for other purposes such as access control lists (ACLs) and traffic engineering.

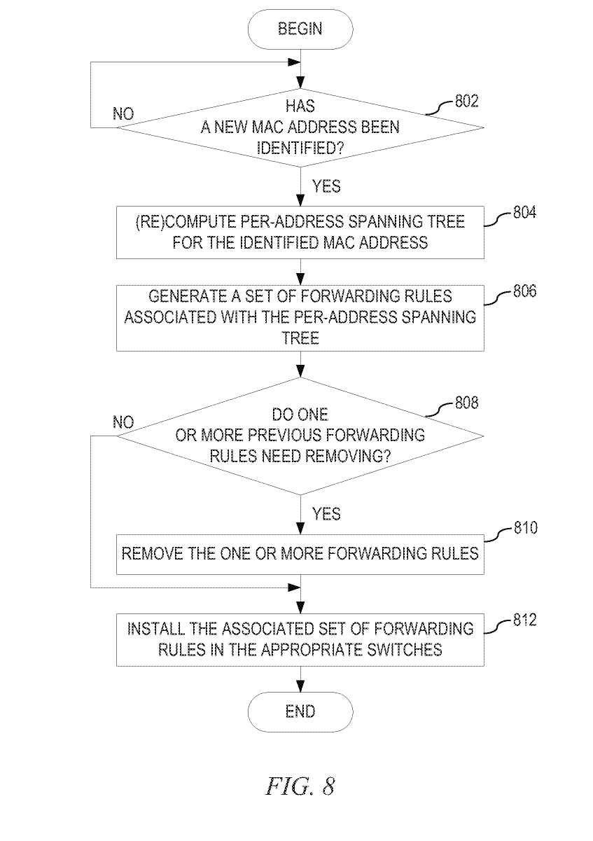

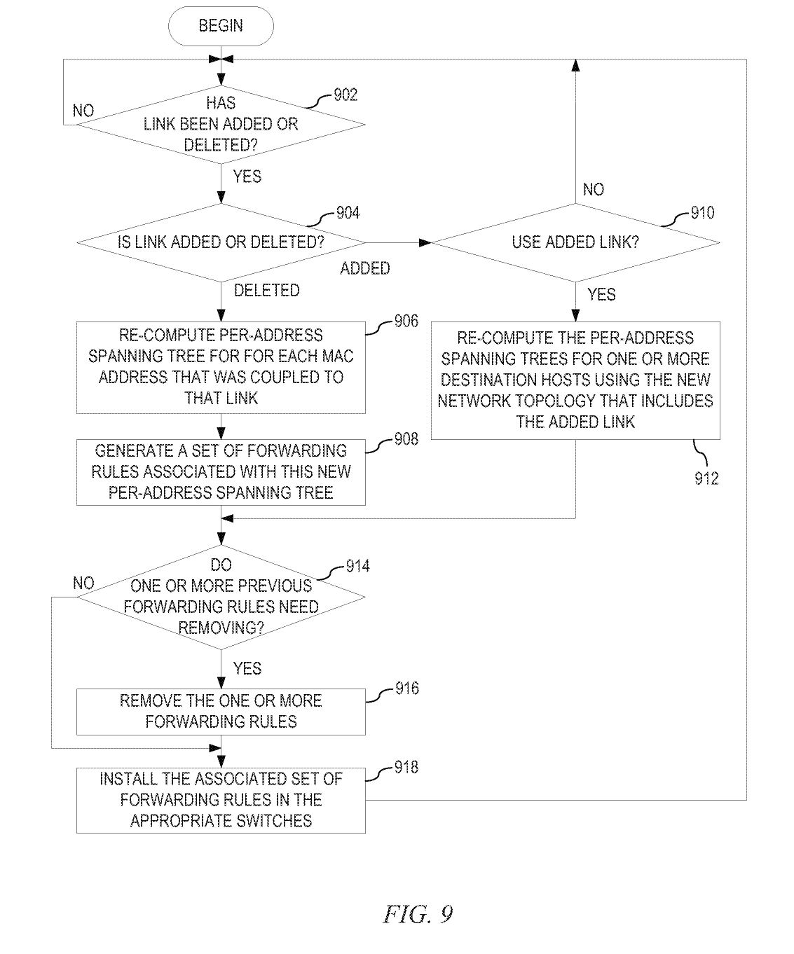

FIG. 8 depicts a flowchart of the operation performed by a per-address spanning tree (PAST) mechanism responsive to an address being added or migrated in accordance with an illustrative embodiment. As the operation begins, the PAST mechanism executed by a processor determines whether a switch in the set of switches has snooped an address that does not match a previously identified address by that switch (step 802). The address may be anew address added by a host coupled to the switch or may be an address that has been migrated from one host to another. If at step 802 no identification of a new or migrated address is made, then the operation returns to step 802. If at step 802 identification is made of a new or migrated address, the PAST mechanism computes, in the case of a new address, or re-computes, in the case of a migrated address, a per-address spanning tree for each the MAC address (step 804). The PAST mechanism then generates a set of forwarding rules associated with the per-address spanning tree (step 806). Then, prior to installing the set of forwarding rules in associated switches that are affected by the new or migrated address, the PAST mechanism determines whether one or more previous forwarding rules need to be removed from the associated switches (step 808). If at step 808 one or more previous forwarding rules need to be removed, then the PAST mechanism removes the one or more forwarding rules (step 810). If at step 808 no forwarding rules need to be removed or after step 810, the PAST mechanism then installs the associated set of forwarding rules in the appropriate switches in parallel (step 812), with the operation ending thereafter. Again, the PAST mechanism installs the associated set of forwarding rules directly in the Ethernet table of the switch so that ICAM entries may be used for other purposes such as access control lists (ACLs) and traffic engineering.

FIG. 9 depicts a flowchart of the operation performed by a per-address spanning tree (PAST) mechanism responsive to a link being added or deleted in accordance with an illustrative embodiment. As the operation begins, the PAST mechanism executed by a processor, determines whether a link coupling a switch to another switch or host has been identified as being added or deleted based on the sent and received link layer discovery protocol (LLDP) messages (step 902). It is noted that the link may also appear as being added or deleted based on a switch appearing or disappearing. If at step 902 no identification is made of an added or deleted link, then the operation returns to step 902.

If at step 902 identification is made of an added or deleted link, then the PAST mechanism determines whether the link is specifically an added link or a deleted link (step 904). If at step 904 the link is a deleted link, the PAST mechanism re-computes a per-address spanning tree for each MAC address that was coupled to that link (step 906). The PAST mechanism then generates a set of forwarding rules associated with this new per-address spanning tree (step 908). If at step 902 the link is an added link, the PAST mechanism chooses whether or not to utilize this new link (step 910). If at step 910 the PAST mechanism chooses not to utilize the new link, the operation returns to step 902. If at step 910 the PAST mechanism chooses to utilize the new link, the PAST mechanism re-computes the per-address spanning trees for one or more destination hosts using the new network topology that includes the added link (step 912). The number of destination hosts for which new per-address spanning trees are computed and the specific hosts that are selected wilt affect the amount of time required to recomputed and reinstall the new per-address spanning trees, as well as the degree to which the new link is utilized.

After step 908 or after step 912 and prior to installing the set of forwarding rules in associated switches that are affected by any new per-address spanning trees, the PAST mechanism determines whether one or more previous forwarding rules need to be removed from the associated switches (step 914). If at step 914 one or more previous forwarding rules need to be removed, then the PAST mechanism removes the one or more forwarding rules (step 916). If at step 914 no forwarding rules need to be removed or after step 916, the PAST mechanism then installs the associated set of forwarding rules in the appropriate switches in parallel (step 918), with the operation returning to step 902 thereafter. Again, the PAST mechanism installs the associated set of forwarding rules directly in the Ethernet table of the switch so that TCAM entries may be used for other purposes such as access control lists (ACLs) and traffic engineering.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the Hock may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart, illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms that address the deficiencies of existing network architectures by providing a per-address spanning tree (PAST) mechanism that provides the traditional Ethernet benefits of self-configuration and host mobility while using all available bandwidth in arbitrary topologies, scaling to very large numbers of hosts (over 100,000 with some commodity switch chips), and running on current commodity hardware. The illustrative embodiment does so by installing routes in the Ethernet table without constraint, which is a previously unexplored point in the design space, and, thus, makes efficient use of the capabilities of commodity switch hardware.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Moderns, cable moderns and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for implementing a per-address spanning tree to direct the forwarding of packets in a set of network switches, the method comprising:
computing the per-address spanning tree for each identified address in a set of addresses thereby forming a set of per-address spanning trees;
generating a set of forwarding rules associated with each per-address spanning tree in the set of per-address spanning trees; and
installing the set of forwarding rules associated with each per-address spanning tree in the set of per-address spanning trees in all appropriate switches in the set of switches for which the per-address spanning tree is generated so that each switch in the set of switches will forward packets based on the set of forwarding rules installed in that switch.

2. The method of claim 1, wherein each address in the set of addresses is a media access control (MAC) address or an internet protocol (IP) address.

3. The method of claim 1, further comprising:
discovering the topology of the set of switches comprising the network; and
detecting a set of addresses handled by each switch in the set of switches,
wherein each address in the set of addresses is an address utilized by a host in a set of hosts that is coupled to a switch in the set of switches.

4. The method of claim 3, wherein the topology is the aggregation of link connectivity between two switches in the set of switches or link connectivity between a switch and a host.

5. The method of claim 4, further comprising:
responsive to the topology being link connectivity between switches in the set of switches and between switches and hosts, discovering the identifier Ds of the switches and hosts that comprise the network.

6. The method of claim 1, wherein the set of rules associated with each per-address spanning tree in the set of per-address spanning trees is installed in all appropriate switches in the set of switches in parallel.

7. The method of claim 1, wherein the set of rules is installed in an Ethernet table of the switch.

8. The method of claim 1, wherein the set of rules is installed utilizing a separate out-of-band control network isolated from links that connect switches in the set of switches to other switches or hosts.

9. A computer program product comprising a computer readable storage medium having a computer readable program stored therein, wherein the computer readable program, when executed on a computing device, causes the computing device to:
compute the per-address spanning tree for each identified address in a set of addresses thereby forming a set of per-address spanning trees;
generate a set of forwarding rules associated with each per-address spanning tree in the set of per-address spanning trees; and
install the set of forwarding rules associated with each per-address spanning tree in the set of per-address spanning trees in all appropriate switches in the set of switches for which the per-address spanning tree is generated so that each switch in the set of switches will forward packets based on the set of forwarding rules installed in that switch.

10. The computer program product of claim 9, wherein each address in the set of addresses is a media access control (MAC) address or an internet protocol (IP) address.

11. The computer program product of claim 9, wherein the computer readable program further causes the computing device to:
discover the topology of the set of switches comprising the network; and
detect a set of addresses handled by each switch in the set of switches,
wherein each address in the set of addresses is an address utilized by a host in a set of hosts that is coupled to a switch in the set of switches.

12. The computer program product of claim 11, wherein the topology is the aggregation of link connectivity between two switches in the set of switches or link connectivity between a switch and a host.

13. The computer program product of claim 12, wherein the computer readable program further causes the computing device to:
responsive to the topology being link connectivity between switches in the set of switches and between switches and hosts, discover the identifier Ds of the switches and hosts that comprise the network.

14. The computer program product of claim 9, wherein the set of rules associated with each per-address spanning tree in the set of per-address spanning trees is installed in all appropriate switches in the set of switches in parallel.

15. The computer program product of claim 9, wherein the set of rules is installed in an Ethernet table of the switch.

16. The computer program product of claim 9, wherein the set of rules is installed utilizing a separate out-of-band control network isolated from links that connect switches in the set of switches to other switches or hosts.

17. An apparatus, comprising:
a processor; and
a memory coupled to the processor, wherein the memory comprises instructions which, when executed by the processor, cause the processor to:
compute the per-address spanning tree for each identified address in a set of addresses thereby forming a set of per-address spanning trees;
generate a set of forwarding rules associated with each per-address spanning tree in the set of per-address spanning trees; and
install the set of forwarding rules associated with each per-address spanning tree in the set of per-address spanning trees in all appropriate switches in the set of switches for which the per-address spanning tree is generated so that each switch in the set of switches will forward packets based on the set of forwarding rules installed in that switch.

18. The apparatus of claim 17, wherein each address in the set of addresses is a media access control (MAC) address or an internet protocol (IP) address.

19. The apparatus of claim 17, wherein the instructions further cause the processor to:
discover the topology of the set of switches comprising the network; and
detect a set of addresses handled by each switch in the set of switches,
wherein each address in the set of addresses is an address utilized by a host in a set of hosts that is coupled to a switch in the set of switches.

20. The apparatus of claim 19, wherein the topology is the aggregation of link connectivity between two switches in the set of switches or link connectivity between a switch and a host.

21. The apparatus of claim 20, wherein the instructions further cause the processor to:
responsive to the topology being link connectivity between switches in the set of switches and between switches and hosts, discover the identifier IDs of the switches and hosts that comprise the network.

22. The apparatus of claim 17, wherein the set of rules associated with each per-address spanning tree in the set of per-address spanning trees is installed in all appropriate switches in the set of switches in parallel.

23. The apparatus of claim 17, wherein the set of rules is installed in an Ethernet table of the switch.

24. The apparatus of claim 17, wherein the set of rules is installed utilizing a separate out-of-band control network isolated from links that connect switches in the set of switches to other switches or hosts.
